(19) United States
(12) Patent Application Publication
(10) Pub. No.: US 2008/0078117 A1
(43) Pub. Date: Apr. 3, 2008

(54) Method for placing young plants in containers

(76) Inventors: Timothy L. Kosderka, Roseburg, OR (US); Jerry C. Barnes, Turner, OR (US); Tina M. Herman, Turner, OR (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 11/536,508

(22) Filed: Sep. 28, 2006

(51) Int. Cl. A01G 1/00

(52) U.S. Cl. 47/58.1 R

(57) ABSTRACT

Methods for placing a container on young plants uses a container application device to quickly and effectively position a container around the young plants. The container application device includes a root section, a shoot section and mouth intermediate the root section and the shoot section. The containers placed on the young plants protects the young plants from wildlife browsing.

### FIELD OF THE DISCLOSURE

The present invention relates to methods for preparing a young plant by placing it in containers for protecting the young plants after they are transplanted.

### BACKGROUND

Wildlife, such as deer, elk, rabbits, are inclined to nibble and eat young plants. This can reduce the seasonal plant growth. Depending upon the extent of damage, the plants' ability to produce food may be lessened. This may result in less ability of the plant to survive later stresses, such as sudden and severe changes in the weather.

Wildlife can also uproot young plants. If these plants are tree seedlings, the uprooting may result in the need for replanting to achieve reforestation. If these plants are crops, such as berry or grape vines, the uprooting may result in the need for new planting to achieve the anticipated crop production.

A current technique for attempting to protect transplanted young plants from being damaged or uprooted by wildlife places the young plants in a protective container that discourages and hinders wildlife efforts to eat or uproot transplanted young plants. One type of protective container is made from an elastic mesh material shaped in the form of a tube. Such type of protective container protects the young plant from damage by wildlife without denying the young plant of the air, moisture and sunlight needed to sustain vigorous growth.

A grower's decision to protect young plants using protective containers depends in part on achieving a favorable balance between the cost of placing young plants in protective containers and the improvement in yield achieved by placing the young plants in the containers. Improvements in the speed and effectiveness of placing young plants in protective containers can lead to desirable reductions in costs.

### SUMMARY

A method for preparing placing young plants, such as vines or tree seedlings, in containers is described below. Exemplary containers include sidewalls which define an opening in at least one end of the container. One specific example of a suitable container comprises a flexible and biodegradable or photodegradable material, such as Vexar® tubing. Such containers can protect the young plants from damage resulting from consumption or uprooting by wildlife. The young plant and container can be planted as a unit, with a portion of the container extending over the shoot end of a young plant to protect it from wildlife. A method for placing a container on a young plant described in more detail below includes steps of placing a container including a first open end, a second end, and a sidewall intermediate the first open end and the second end on a container application device that includes a body having a root section, a shoot section, and a mouth intermediate the root section and the shoot section. A container is positioned on the container application device such that at least a portion of the sidewall of the container is positioned around the root section of the device. A young plant including a root end and a shoot are placed on the container application device, with the root end and shoot positioned at least partially within the shoot section of the container application device. A portion of the container sidewall is moved from the root section to the shoot section of the container application device. Movement of the portion of the sidewall from the root section to the shoot section of the container application device results in a portion of the container being positioned around portions of the young plant. Optionally, the plant in the container may be frozen prior to planting.

In another method for placing a container on a young plant, a container having a first open end, second end, and a sidewall intermediate the first open end and the second end is placed on an application container device. The application container device includes a body having a root section, a shoot section, and a mouth intermediate the root section and the shoot section. At least a portion of the sidewall of the container is positioned around the root section of the container application device. A young plant having a root end and a shoot is placed in the shoot section of the container application device. At least a portion of the sidewall is moved from the root section to the shoot section of the container application device while the young plant is positioned within the shoot section of the container application device. This movement results in the sidewall of the container being positioned around at least a portion of the young plant.

In another method for placing a container on a young plant, a container having a first open end, a second end, and a sidewall intermediate the first open end and the second end is employed. The first open end of the container is held open with a container application device and a young plant having a root end and a shoot is placed on the container application device. The sidewall of the container is then positioned around at least a portion of the young plant. The container application device used in this method includes a body having a root section, a shoot section, and a mouth intermediate the root section and the shoot section.

### BRIEF DESCRIPTION OF THE DRAWINGS

The foregoing aspects and many of the attendant advantages of the subject matter described herein will become more readily appreciated as the same become better understood by reference to the following detailed description, when taken in conjunction with the accompanying drawings, wherein

FIG. 1 illustrates an exemplary container and a young plant, to which the container is to be applied;

FIG. 2 illustrates a perspective view of a container application device used in methods described herein;

FIG. 3 illustrates a cross-sectional view of a container application device taken along line 3-3 in FIG. 2;

FIG. 4 illustrates an end view of the first end of the container application device illustrated in FIG. 1;

FIG. 5 illustrates an end view of the second end of the container application device of FIG. 2;

FIG. 6 is a bottom view of the container application device of FIG. 2; and

FIG. 7 is a top view of the container application device of FIG. 2.

FIG. 8 illustrates one stage of a method for placing a container on a young plant described herein;

FIG. 9 illustrates a second stage of a method for placing a container on a young plant;

FIG. 10 illustrates a third stage of a method for placing a container on a young plant; and

FIG. 11 illustrates an alternative step useful in a method for placing a container on a young plant.

### DETAILED DESCRIPTION OF THE INVENTION

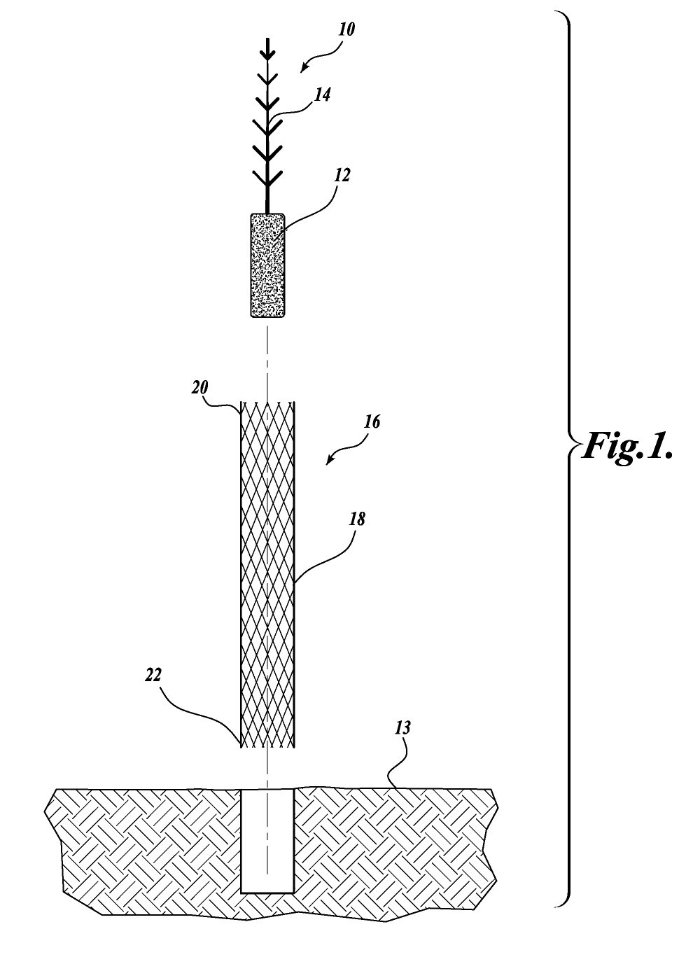

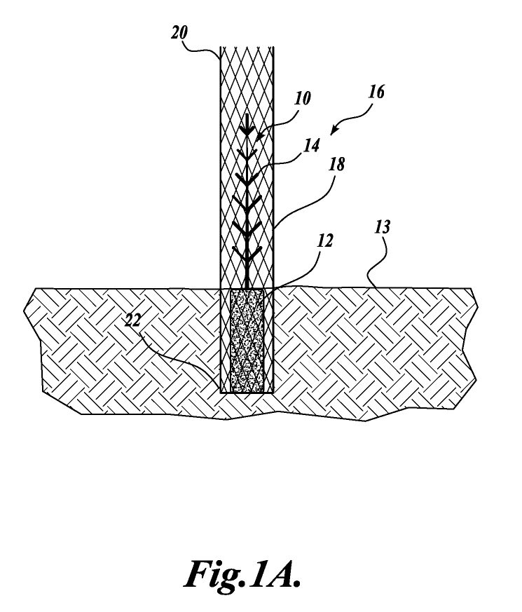

Referring to FIG. 1, a young plant 10 such as young tree seedlings, vines, shrubbery or other foliage that are to be placed in a container 16 having at least one sidewall 18 and an open first end 20 and a second open end 22 opposite the first open end 20 is illustrated. Container 18 can have a cross-section perpendicular to its length that is generally circular or the cross-sectional shape can be non-circular, e.g., oval, square, or elliptical. The illustrated young plant 10 includes a root end 12 and a shoot 14. Root end 12 refers to the portion of the young plant commonly referred to as the root ball. Shoot 14 protrudes from root end 12. As illustrated in FIG. 1a, a sidewall 18 extends over substantially all of root end 12 and shoot 14 of young plant 10. It should be understood that the length of sidewall 18 may be such that it extends substantially beyond the shoot 14 while also extending over substantially all of root end 12 or the length of sidewall 18 may be such that it extends over only a portion of root end 12 and/or only a portion of shoot 14. The perimeter dimension of the cross-section of container 16 perpendicular to its length should be large enough to allow the container to receive the root end and shoot of the young plant within the container. When the container is made of a flexible, elastic material, this perimeter dimension may be achieved by stretching the container.

Container 16 may be formed from a variety of materials. In one embodiment, container 16 is made from materials flexible enough to allow the container and plant 10 to be grasped and planted as a unit while at the same time being rigid enough so that the container remains substantially upright around the plant 10 when planted in soil 13. The material may be biodegradable in the field over a period of a few years. The material should allow light, carbon dioxide, and other nutrients, to pass through and be received by root end 12 and shoot 14. Suitable materials for container 1.6 include biodegradable or photodegradable netting or mesh, such as Vexar® plastic netting produced by the E.I. du Pont de Nemours and Company of Wilmington, Del. or Vexar® polymer molded into tubing by Quadel Industries in Coos Bay, Oreg.

Plant 10 may be a containerized plant, plug seedling, bare root seedling or a plant grown in a container. The plant growing container used to grow the plant may be shaped to provide a root end 12 of a plant 10 that can be received by container 16. The plant may alternatively be grown in a planting tray. The planting tray may have individual planting compartments shaped for producing a young plant with a root end 12 sized and shaped to be received by container 16. Alternatively, container 16 can be sized and shaped to receive root ends of different shape.

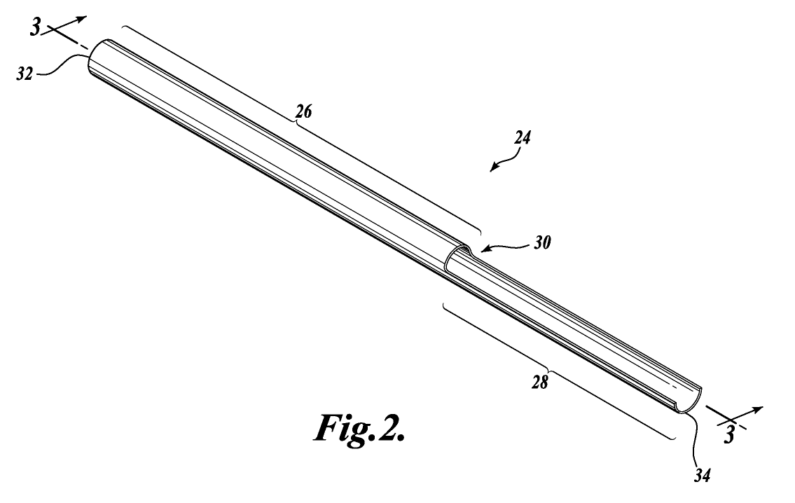

Referring to FIGS. 2-7, a method for placing a container on a young plant uses a container application device 24. An exemplary container application device 24 includes an elongated tubular body that includes a first end 32 and a second end 34. Intermediate first end 32 and second end 34 is mouth 30. The body of container application device 24 between first end 32 and mouth 30 comprises a cylinder having a circular cross-section. The portion of the body of container application device 24 extending between mouth 30 and second end 34 includes a cylinder having a circular cross-section with a portion of the top of the cylinder removed to provide a trough that forms shoot section 28. The portion of the body of container application 24 that extends from first end 32 to mouth 30 forms root section 26. Root section 26, shoot section 28, and mouth 30 are used in a method for placing a container on a young plant as described below in more detail.

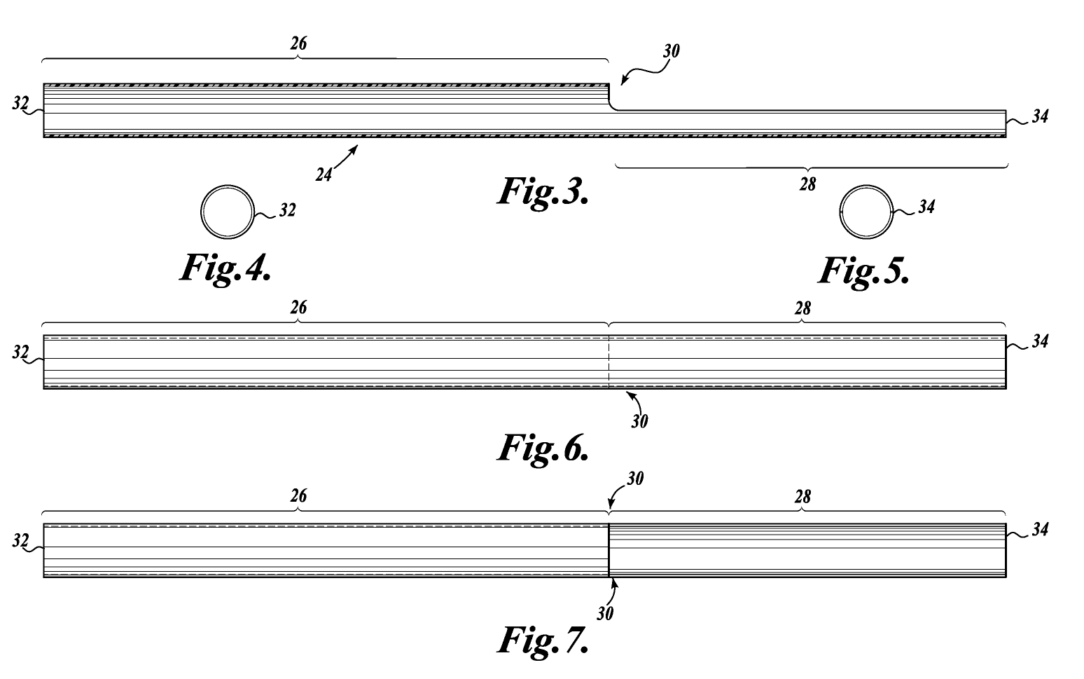

FIG. 3 illustrates a cross-sectional view of container application device 24 in FIG. 1 and provides a different perspective of the portion of the container application device body cut away to form the trough of shoot section 28.

Container application device 24 illustrated in FIGS. 2-7 has a round cross-section perpendicular to its length; however it is understood that container application device 24 can have a cross-section perpendicular to its length that is noncircular in shape, e.g. square, elliptical, or rectangular. In addition, in the illustrated container application device, one half of the cylinder making up shoot section is removed; however, it should be understood that more than one half or less than one half could be removed. Also, the relative lengths of root section 24 and shoot section 28 can vary from those illustrated in FIGS. 2-7. Suitable materials for container application device 24 include plastic and metal, for example, polyvinylchloride or copper tubing.

The diameter or cross-sectional perimeter dimension of container application device 24 may vary. Suitable diameters or perimeter dimensions include those that allow for root end 12 and shoot end 14 of a young plant to be received in the trough of shoot section 28. The diameter or perimeter dimension of the cross-section of root section 26 should be chosen so that root end 12 of the young plant can be received within root section 26 though mouth 30. The diameter of root section 26 and shoot section 28 in container application device 24 illustrated in FIGS. 2-7 is the same; however it should be understood that the diameter or perimeter dimension of root section 26 and the diameter or perimeter dimension of shoot section 28 could be different.

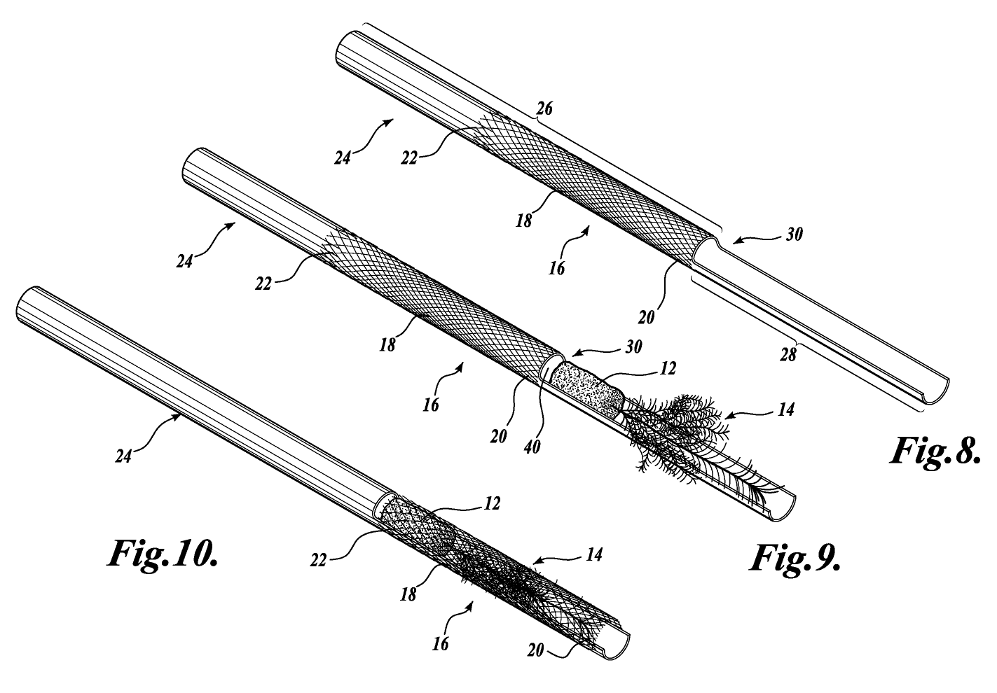

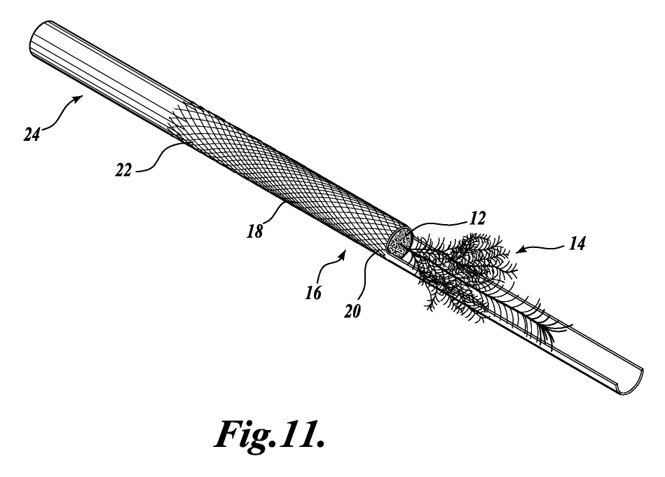

Referring to FIGS. 8-10, container application device 24 is employed to apply a container 16 to a young plant 10 as described below. In the method for applying a container to a young plant described herein referring to FIG. 8, a container 16 is placed around root section 26 of container application device 24. Container 16 is placed on root section 26 and positioned so that first end 20 of container 16 is adjacent mouth 30. First end 20 can either he around a portion of shoot section 28 or around a portion of root section 26. Preferably, first end 20 is around a portion of root section 26 so that first end 20 is held open by root section 26. Referring to FIG. 9, after container 16 is placed around root section 26 of container application device 24, young plant 10, including root end 12 and shoot 14 is placed within the trough of shoot section 28. As illustrated in FIG. 9, it is preferred that a gap 40 be provided between the mouth 30 and a distal end of root end 12. Gap 40 provides a space where a user can place his/her fingers or a device that can be used to slide young plant 10 and container 16 off of container application device 24. After young plant 10 is positioned within container application device 24, container 16 is moved from root section 26 to shoot section 28, effectively placing container 16 around a portion of root end 12 and shoot 14 of young plant 10 as depicted in FIG. 11. Depending upon the length of the container 16 and the length of young plant 10, first end 20 of container 1.6 may be located beyond shoot 14 of the young plant 10, and second end 22 of container 16 may be located beyond the end of root end 12. After container 16 has been applied to young plant 10, the combination is removed from container application device 24 and may be further processed for storage, transportation, and transplanting.

As an alternative step in the methods described herein, referring to FIG. 11, after young plant 10 has been placed in shoot section 28, a portion of root end 12 can be moved into root section 26 of container application device 24. Placing root end 12 within root section 26 isolates root end 12 from container 16. In certain situations, such isolation may be desirable in order to prevent container 16 from becoming tangled with portions of root end 12. After root end 12 is placed within root section 26, container 16 is moved from root section 26 to shoot section 28, effectively positioning container 16 around shoot 14 and root end 12. Thereafter, root end 12 can be removed from root section 26 and the entire combination removed from container application device 24 by sliding it off of shoot section 28.

After the plant 10 is placed into the container 16, the combination may be frozen to store the combination until it is planted. The combination may be frozen at a temperature below 1° C., such as below 2° C., or such as below 3° C. A typical temperature range used to freeze the combination is between minus 1° C. and minus 5° C. The combination may be stored at a temperature at which the plant remains frozen, typically between minus 1° C. and minus 5° C. The frozen combination may typically be stored for a period of from one month to six months, although the combination may be stored for longer than six months if desired (e.g., for a period in the range of from six months to two years, or for a period in the range of from six months to three years, or for a period in the range of from six months to four years).

While different embodiments have been illustrated and described, it will he appreciated that various changes can be made therein without departing from the spirit and scope of the subject matter described herein.

We claim:

1. A method for preparing a young plant, comprising:
placing a container comprising a first open end, a second end, and a sidewall intermediate the first open end and the second end on a container application device including a body having a root section, a shoot section, and a mouth intermediate the root section and the shoot section;
positioning at least a portion of the sidewall around the root section;
placing a young plant on the container application device, the young plant including a root end and a shoot;
positioning the root end and the shoot at least partially within the shoot section; and
moving at least a portion of the sidewall from the root section to the shoot section of the container application device.

2. The method of claim 1, wherein the container further comprises an open mesh material.

3. The method of claim 1, wherein the second end is open.

4. The method of claim 1, wherein the container comprises a tube.

5. The method of claim 1, wherein the root section comprises a tube.

6. The method of claim 1, wherein the shoot section comprises a trough.

7. The method of claim 1, wherein the step of positioning at least a portion of the sidewall around the root section further comprises placing the first open end around the root section.

8. The method of claim 1, further comprising positioning the root end at least partially within the root section of the container application device.

9. The method of claim 8 wherein the step of positioning the root end at least partially within the root section of the container application device further comprises positioning all of the root end within the root section.

10. The method of claim 8 or 9, further comprising moving a portion of the root end in the root section to the shoot section.

11. The method of claim 1, further comprising removing the container and young plant from the container application device with the container around at least a portion of the root end and at least a portion of the shoot.

12. The method of claim 11, wherein the container is around substantially all the shoot.

13. The method of claim 12, wherein the container is around substantially all the root end.

14. The method of claim 11, wherein the container and young plant are frozen after the young plant is placed inside the container.

15. A method for preparing a young plant, comprising.
placing a container comprising a first open end, a second end, and a sidewall intermediate the first open end and the second end on a container application device including a body having a root section, a shoot section, and a mouth intermediate the root section and the shoot section;
positioning at least a portion of the sidewall around the root section;
placing a young plant in the shoot section of the container application device, the young plant including a root end and a shoot; and
moving at least a portion of the sidewall from the root section to the shoot section of the container application device while the young plant is positioned within the shoot section of the container application device.

16. The method of claim 15, wherein the step of placing a young plant in the shoot section of the container application device further comprises, providing a gap between the mouth and the root end of the young plant.

17. A method for preparing a young plant, comprising:
providing a container comprising a first open end, a second end, and a sidewall intermediate the first open end and the second end;
providing a container application device comprising a body having a root section, a shoot section, and a mouth intermediate to root section and the shoot section;
placing the container on the container application device;
providing a young plant having a root end and a shoot on the container application device;
maintaining the first end open using the container application device; and
positioning the sidewall around at least a portion of the shoot.
